(19) United States
(12) Patent Application Publication
(10) Pub. No.: US 2005/0096930 A1
(43) Pub. Date: May 5, 2005

(54) Methods, calculators and computer program products for estimating cost savings attributed to backup power systems

(76) Inventor: Marcus A. Maxwell, Wake Forest, NC (US)

Correspondence Address: Elizabeth A. Stanek;Myers Bigel Sibely & Sajovec, P.A., Post Office Box 37428, Raleigh, NC, 27627, US

(21) Appl. No.: 10/701,850

(22) Filed: Nov. 5, 2003

(51) Int. Cl. G06F 17/60

(52) U.S. Cl. 705/1

(57) ABSTRACT

Methods, calculators and computer program products for estimating a cost savings attributable to use of a backup power system include a data processing system is configured to obtain historical power status information relating to operation of the backup power system and compute an estimate of cost savings from the obtained historical power status information.

### BACKGROUND OF THE INVENTION

The present invention relates generally to power supply apparatus and methods of operation thereof, and more particularly, to management software configured to interact with uninterruptible power supplies (UPSs) and methods of operation thereof.

UPSs are commonly used to provide conditioned and/or auxiliary power to electronic equipment that provides critical functions, such as computer systems, telecommunications systems and medical equipment. Typically, UPSs can provide AC power from a backup source, such as a battery, generator or fuel cell, in the event that a utility power supply fails or becomes degraded.

Many conventional UPSs may be configured to be monitored and/or controlled by software operating on a computer coupled to the UPS, for example, LanSafe™ power management software offered by Powerware Corporation. The software may enable a company utilizing one or more UPSs to manage and monitor the UPSs from a remote location. The purchase and installation of UPS systems and software related thereto may initially be costly. However, the presence of power protection may ultimately be a cost saver. For example, when power is lost, a company having power protection may continue to operate and, thus, may not lose money associated with down time due to the power loss. At the very least, the presence of power protection may allow users to save information before shutting the equipment down, thus, completed work may not have to be duplicated. Accordingly, the initial cost of backup power systems may be small relative to the savings provided.

### SUMMARY OF THE INVENTION

Embodiments of the present invention provide methods, calculators and computer program products for estimating a cost savings attributable to use of a backup power system. A data processing system is configured to obtain historical power status information relating to operation of the backup power system and compute an estimate of cost savings from the obtained historical power status information.

In some embodiments of the present invention, the obtained historical power status information may include a number of power failures and/or a duration of the power failures. A one-time cost factor for a single power failure may be obtained and a cost per hour without power factor may also be obtained.

In further embodiments of the present invention, the estimate of cost savings may be provided by calculating a per incident savings estimate based on the number of power failures and the one-time cost factor. An hourly savings estimate may be calculated based on the duration of the power failures and the cost per hour without power factor. The estimate of cost savings associated with the backup power system may be calculated based on the calculated per incident savings estimate and the calculated hourly savings estimate.

In still further embodiments of the present invention, the per incident savings estimate, the hourly savings estimate and/or the estimate of cost savings to a computer application may be exported to a computer application. In certain embodiments of the present invention, the one-time cost factor, the cost per hour factor, the number of power failures, the duration of the power failures, the per incident savings estimate, the hourly savings estimate and the estimate of cost savings may be displayed on a graphical user interface (GUI).

### BRIEF DESCRIPTION OF THE DRAWINGS

FIG. 1 is a block diagram of a data processing system suitable for use in embodiments of the present invention.

FIG. 2 is a more detailed block diagram of a system according to embodiments of the present invention.

FIG. 3 is a block diagram illustrating embodiments of the present invention illustrated in an exemplary network environment.

FIG. 4 is a diagram of graphical user interfaces (GUIs) suitable for use in some embodiments of the present invention.

FIG. 5 is a flowchart illustrating operations according to some embodiments of the present invention.

FIG. 6 is a flowchart illustrating operations according to further embodiments of the present invention.

FIG. 7 is a flowchart illustrating operations according to still further embodiments of the present invention.

### DETAILED DESCRIPTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention may be embodied as methods, data processing systems, and/or computer program products. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions/acts specified in the flowchart and/or block diagram block or blocks.

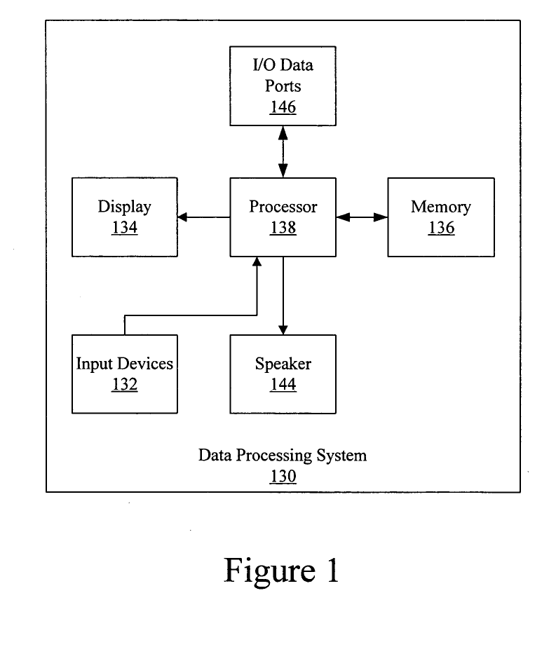

Various embodiments of the present invention will now be described with reference to FIGS. 1 through 7. Embodiments of the present invention provide methods, calculators and computer program products that compute an estimate of cost savings attributed to backup power systems based on obtained historical power status information. The estimated cost saving may be used to illustrate the cost benefit of utilizing backup power systems. Accordingly, embodiments of the present invention may, for example, provide a way of quantifying the cost benefit of backup power systems as well as a justification for future investments in backup power systems.

Referring now to FIG. 1, an exemplary embodiment of a data processing system 130 suitable for use in accordance with embodiments of the present invention will be discussed. The data processing system 130 typically includes input device(s) 132 such as a keyboard or keypad, a display 134, and a memory 136 that communicate with a processor 138. The data processing system 130 may further include a speaker 144, and an I/O data port(s) 146 that also communicate with the processor 138. The I/O data ports 146 can be used to transfer information between the data processing system 130 and another computer system or network. These components may be conventional components, such as those used in many conventional data processing systems, which may be configured to operate as described herein.

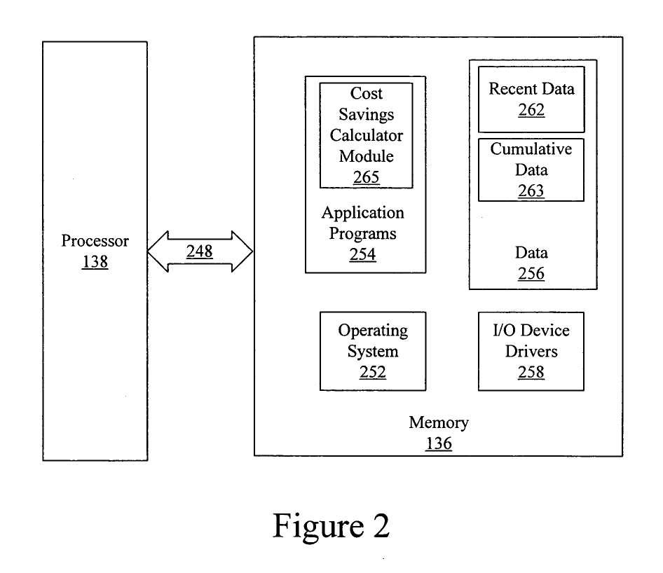

Referring now to FIG. 2, a block diagram of a data processing system that illustrates methods, calculators and computer program products in accordance with embodiments of the present invention will be discussed. The processor 138 communicates with the memory 136 via an address/data bus 248. The processor 138 can be any commercially available or custom microprocessor. The memory 136 is representative of the overall hierarchy of memory devices containing the software and data used to implement the functionality of the data processing system 130. The memory 136 can include, but is not limited to, the following types of devices: cache, read only memory (ROM), programmable ROM (PROM), electrically programmable ROM (EPROM), erasable electrically programmable ROM (EEPROM), flash memory, static random access memory (SRAM), and dynamic random access memory (DRAM).

As shown in FIG. 2, the memory 136 may include several categories of software and data used in the data processing system 130: an operating system 252; application programs 254; input/output (I/O) device drivers 258; and data 256. As will be appreciated by those of skill in the art, the operating system 252 may be any operating system suitable for use with a data processing system, such as OS/2, AIX or zOS from International Business Machines Corporation, Armonk, N.Y., Windows95, Windows98, Windows2000 or WindowsXP from Microsoft Corporation, Redmond, Wash., Unix or Linux. The I/O device drivers 258 typically include software routines accessed through the operating system 252 by the application programs 254 to communicate with devices such as the I/O data port(s) 146 and certain memory 136 components. The application programs 254 are illustrative of the programs that implement the various features of the data processing system 130 and preferably include at least one application that supports operations according to embodiments of the present invention. Finally, the data 256 represents the static and dynamic data used by the application programs 254, the operating system 252, the I/O device drivers 258, and other software programs that may reside in the memory 136.

As further illustrated in FIG. 2, the application programs 254 may include a cost savings calculator module 265 according to embodiments of the present invention. The cost savings calculator module 265 may compute an estimate of cost savings attributed to backup power systems based on obtained historical power status information. The data portion 256 of memory 136 may include the historical power status information used by the cost savings calculator as described herein. As illustrated in FIG. 2, historical power status information may include both recent power status data and cumulative power status data 263 that may be used by the cost savings calculator module 265 to calculate cost savings provided by backup power system as also discussed herein.

While the present invention is illustrated, for example, with reference to the cost savings calculator module 265 being an application program in FIG. 2, as will be appreciated by those of skill in the art, other configurations may also be utilized while still benefiting from the teachings of the present invention. For example, the cost savings calculator module 265 may also be incorporated into the operating system 252 or other such logical division of the data processing system 130. Thus, the present invention should not be construed as limited to the configuration of FIG. 2 but is intended to encompass any configuration capable of carrying out the operations described herein.

Furthermore, while the cost savings calculator module 265 is illustrated in a single data processing system, as will be appreciated by those of skill in the art, such functionality may be distributed across one or more data processing systems. Thus, the present invention should not be construed as limited to the configuration illustrated in FIGS. 1 through 2 but may be provided by other arrangements and/or divisions of function between data processing systems.

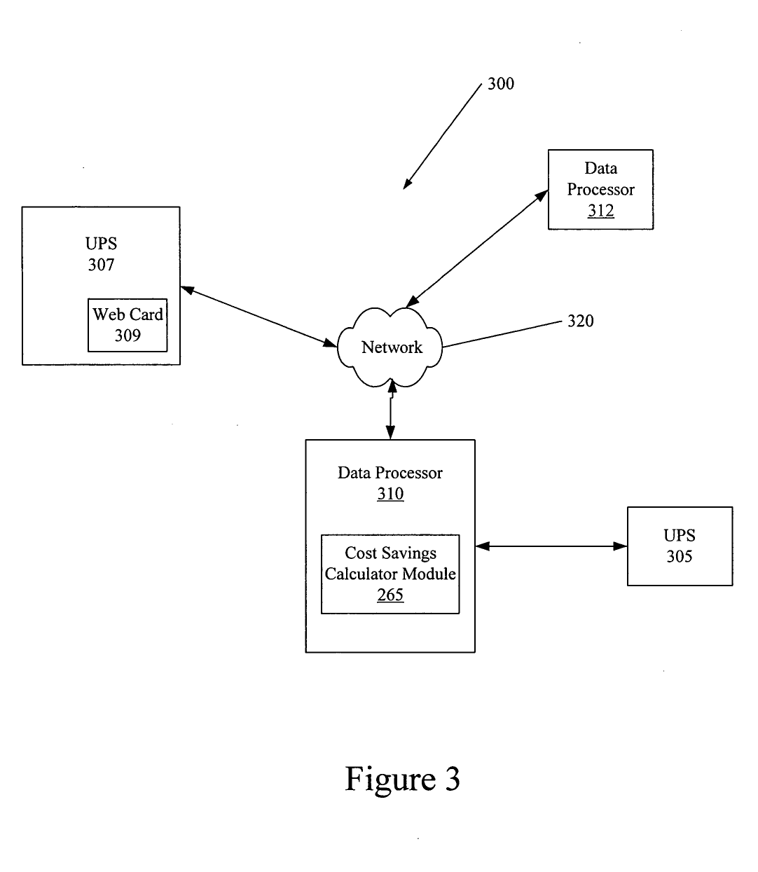

Referring now to FIG. 3, a block diagram of various exemplary embodiments of the present invention implemented in an exemplary network environment 300 will be described. In some embodiments of the present invention, a data processor 310, for example, a laptop computer, a desktop computer, a personal data assistant (PDA), a web capable mobile terminal or similar device is configured to communicate with a UPS 305, for example, over an RS-232 or similar link. The data processor 310 may have a cost savings calculator module 265 resident thereat that is operative to receive historical power status information from the UPS 305.

In other embodiments of the present invention, such a data processor 310 may be configured to communicate with a web card 309 of a UPS 307 over a network 320, for example, a local area network (LAN), wide area network (WAN) or other network, to receive historical power status information. As shown in FIG. 3, the data processor 310 may be further operative to provide cost savings estimates to another data processor 312, for example, for display at a remote location.

It will be further understood that the network environment illustrated in FIG. 3 is provided for exemplary purposes only and that the invention is not limited to this configuration. It will be further understood that the system illustrated in FIG. 3 may include one or two or more UPSs, one or more communications devices 310 and one or more networks 320 without departing from the scope of the present invention.

Exemplary operations of the present invention will now be discussed with respect to FIGS. 1 through 3. As illustrated, in some embodiments of the present invention, the communications device 310 may be coupled to a first UPS 305 via, for example, a serial data link. In other embodiments of the present invention, the communications device 310 may be coupled to a second UPS 307 through the network 320. As illustrated, the second UPS 307 may include a web card 309 that may enable the second UPS 307 to communicate with the communications device 310 through the network 320. The cost savings calculator module 265 may be configured to track historical power status information associated with the first UPS 205, the second UPS 307 or both. For example, the cost savings calculator module 265 may be configured to track the number of times the first UPS 305 has been used to provide power from a secondary source, for example, a battery, generator or a fuel cell. The cost savings calculator module 265 may also be configured to track the duration of the power failures, i.e., the amount of time the first UPS 305 provided power from the secondary source.

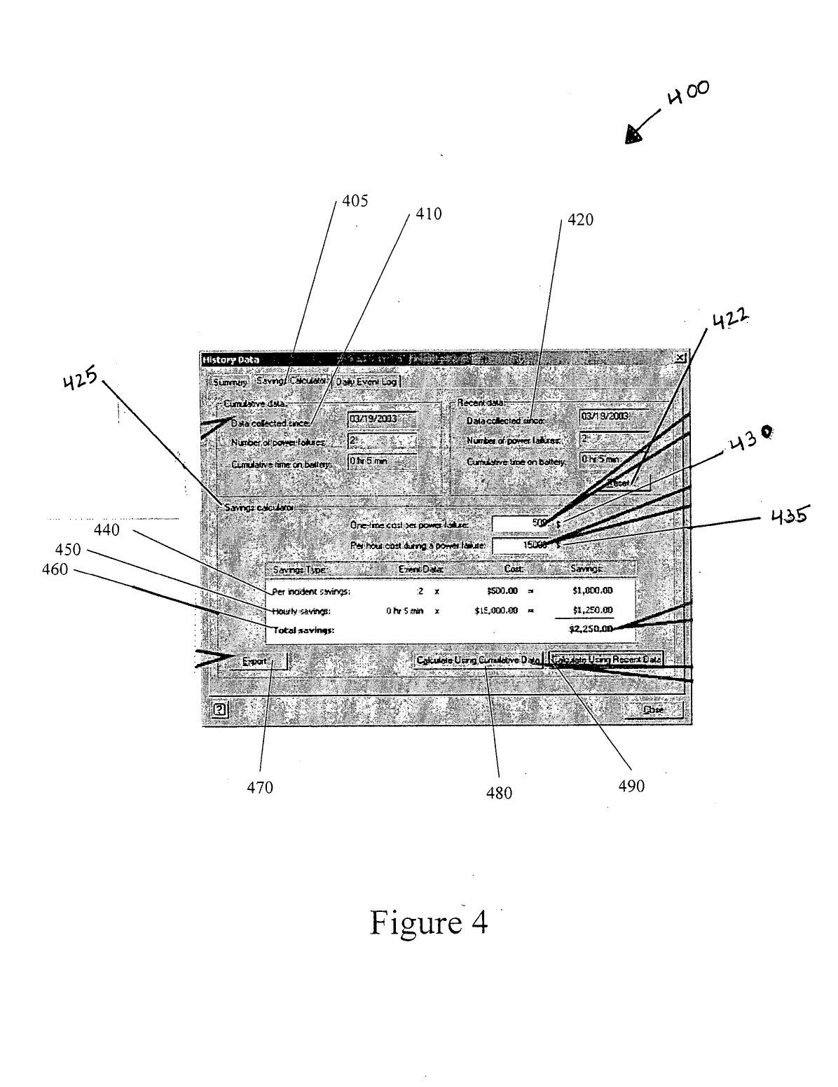

It will be understood that the cost savings calculator module 265 may be integrated with power management software, for example, LanSafe™ provided by Powerware Corporation. The power management software may be configured to track the historical power status information and provide the historical power status information to the cost savings calculator module 265. Alternatively, the user may provide the historical power status information through, for example, a keyboard or a mouse and a user interface. In certain embodiments of the present invention, the user interface may be, for example, a graphical user interface (GUI), which may be displayed by the communications device 310. The GUI may include fields in which the user may provide historical power status information as well as other information used by the cost savings calculator module 265 to compute an estimate of cost savings provided by the backup power system (UPSs 305 and 307). Embodiments of an exemplary GUI according to embodiments of the present invention will be discussed further below with respect to FIG. 4.

The cost savings calculator module 265 may be further configured to obtain power outage cost factors associated with the first UPS 305. The cost information may include a one-time cost factor for a single power failure and/or a cost per hour without power factor. The one-time costs may take into account data loss, customer transaction failures, hardware and/or software infrastructure failures and the like. The one-time costs may be experienced by a company any time a power loss occurs, even if the power is only lost for a short period of time. The cost per hour without power may take into account hourly rates for idle employees, missed transaction opportunities and the like. This cost information may be provided by the user of the cost savings calculator module 265 or the cost savings calculator module 265 may provide default values for these variables. The default values may be, for example, average cost information based on information provided from multiple source.

Once the cost savings calculator module 265 has received the historical power status information and the power outage cost factors, the cost savings calculator module 265 may calculate the estimate of cost savings based on the historical power status information and the cost information. For example, the cost savings calculator module 265 may be configured to calculate a per incident savings estimate based on the number of power failures and the one-time cost factor. Thus, if there have been two power failures and the one-time cost associated with a single power failure is five hundred dollars, the per incident savings estimate would be one thousand dollars. Furthermore, the cost savings calculator module 265 may be further configured to calculate an hourly savings estimate based on the duration of the power failures and the cost per hour without power factor. Thus, if the total duration of the two power failures is 1.5 hours and the per hour cost of a power failure is 15,000 dollars, the hourly savings estimate would be 22,500 dollars. Accordingly, the estimate of cost savings would be the sum of the per incident savings estimate and the hourly savings estimate, or 23,500 dollars (1000 dollars plus 22,500 dollars). It will be understood that the cost savings calculator module 265 according to some embodiments of the present invention may be configured to compute an estimate of cost savings for a particular period of time using the recent data 262 or a cumulative cost savings estimate for a longer period of time using the cumulative data 263.

The cost savings calculator module 265 may be configured to export the historical power status information, the cost information and the estimate of cost savings to a computer application running on, for example, the communications device 310. For example, the information may be exported to a word processor or a spreadsheet for further analysis, storage or reporting purposes.

It will be understood that the example discussed above with respect to FIGS. 1 through 3 is not intended to limit embodiments of the present invention and is provided for exemplary purposes only. Operations according to embodiments of the present invention may include additional steps or omit steps discussed above without departing from the scope of the present invention. Furthermore, the steps may be combined or performed in a different order than discussed above.

Embodiments of the present invention for calculating a cost savings provided by backup power systems may provide many user configurable options for the calculation as discussed above. Embodiments of the present invention may provide a user-friendly graphical user interface (GUI) that walks the user through the operations of the present invention discussed with respect to FIGS. 1 through 3 above.

As illustrated in FIG. 4, a GUI 400, according to embodiments of the present invention, may provide history data including a summary view, a savings calculator view and daily event log view. The savings calculator view 405 may provide a user interface for the savings calculator module 265 according to some embodiments of the present invention. It will be understood that the GUI 400 illustrated in FIG. 4 is provided for exemplary purposes only and that GUIs according to embodiments of the present invention are not limited to the GUIs illustrated herein.

As illustrated in the exemplary window of FIG. 4, the “Savings calculator” view 405 includes selectable displays for, among other things, cumulative data 410, recent data 420 and a savings calculator 425. The cumulative data display 410 may include a user interface for providing information about the backup system, for example, the date on which data collection began, the number of power failures since this date and the cumulative amount of time a secondary power source was accessed, for example, a battery. The recent data display 420 may include a similar user interface, but may also include a reset button 422 that allows the date of data collection to be reset to allow more recent data about the backup power system to be obtained. The savings calculator display 425 may include a user interface for providing cost information, for example, one-time cost of a power failure 430 and/or a per hour cost of a power failure 435. It will be understood that the information in the cumulative data display 410, the recent data display 420 and the savings calculator display 425 may be provided by the user. However, as discussed above, this information may also be provided by management software configured to keep track of the power failures experienced by associated UPSs and the duration of the power failures. As further discussed above, default values may also be provided for fields such as the one-time cost field 430 and/or the per hour cost field 435.

As illustrated in FIG. 4, the savings calculator display 425 may also include an export button 470, a calculate using cumulative data button 480 and a calculate using recent data button 490. The export button 470 may be used to export cost calculations and related cost/historical power status information to word processor applications or spreadsheets. For example, the calculated per incident savings 440, hourly savings 450 and/or the total cost savings 460 may be exported to a word processing document or a spreadsheet to be further analyzed, stored and/or reported as discussed above. Similarly, the calculate using cumulative/recent data buttons 480 and 490 may be used to calculate the estimate of total cost savings 460 using particular data in either the cumulative data display 410 or the recent data display 420.

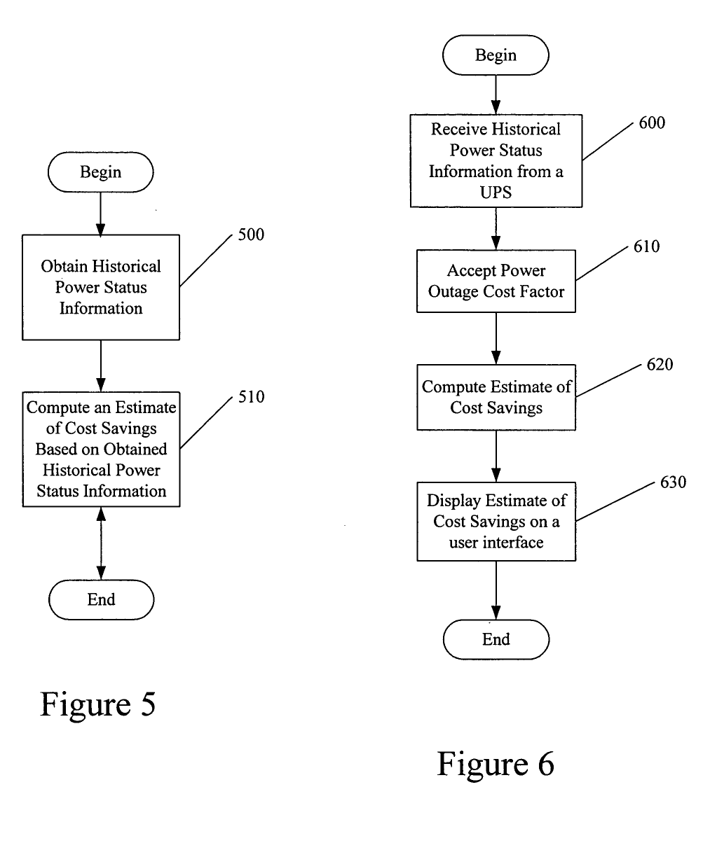

Operations of cost savings calculator modules according to embodiments of the present invention will now be discussed further with respect to the flowcharts of FIGS. 5 and 6. Referring now to FIG. 4, operations begin at block 500 by obtaining historical power status information. Historical power status information may include cumulative or recent data related to the number of power failures, duration of these power failures or the like. The historical power status information may be used to compute an estimate of cost savings attributed to the presence of backup power system (block 510).

Referring now to FIG. 6, operations according to further embodiments of the present invention will be discussed. Operations begin at block 600 by receiving historical power status information from a UPS. The historical power status information may be received from the UPS over a communications link. The historical power status information may include a number of power failures and/or a duration of the power failures. The power outage cost factor may be received from a user interface (block 610). The power outage cost factor may include, for example, a one-time cost factor for a single power failure and/or a factor for cost per hour without power. An estimate of cost savings may be computed based on the historical power status information and the power outage cost factor (block 620). The estimate of cost savings may be displayed on the user interface (block 630). In certain embodiments of the present invention, the user interface may be a graphical user interface (GUI).

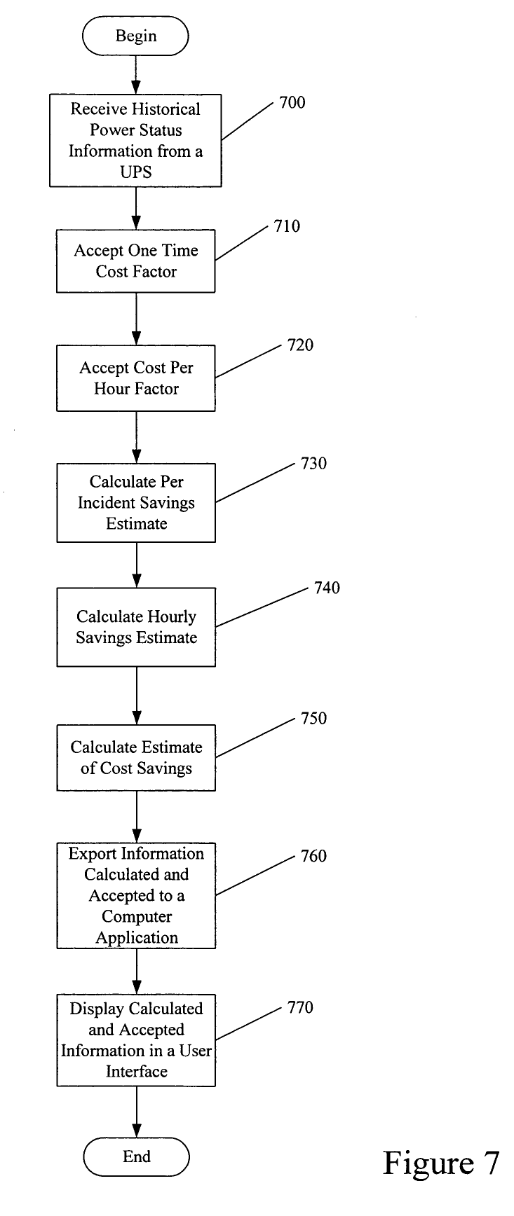

Referring now to FIG. 7, operations begin at block 700 by receiving historical power status information. A one-time cost factor of a power failure may be accepted (block 710) as well as a per hour cost factor (block 720). The cost factors may be entered by a user through, for example, a user interface. Alternatively, the cost factors may be obtained by management software running on a communications device coupled to a UPS (backup power system). The one-time cost factor and the per hour cost factor may be used to calculate a per incident savings estimate (block 730) and an hourly savings estimate (block 740), respectively. The per incident savings estimate and hourly savings estimate may be used to calculate an estimate of cost savings provided by the UPS (block 750). The accepted and calculated values may be exported from the cost savings calculator module to a word-processed document or a spreadsheet (block 760) for use in further analysis, storage or reporting. Finally, in certain embodiments of the present invention, the accepted and calculated information may be displayed on a user interface, for example, a GUI (block 770).

As discussed briefly above with respect to FIGS. 1 through 7, embodiments of the present invention provide methods, calculators and computer program products for computing an estimate of cost savings related to the presence of power backup systems. The cost savings calculator module according to embodiments of the present invention may allow users of UPSs to realize the cost benefit of a UPS solution as well as justify future UPS investments. Accordingly, embodiments of the present invention may provide a distinct value and this value may be easily exported into, for example, financial reports or spreadsheets, which may be used to illustrate the cost benefits of a UPS solution.

The flowcharts and block diagrams of FIGS. 1 through 7 illustrate the architecture, functionality, and operation of possible implementations of systems, methods and computer program products according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

In the drawings and specification, there have been disclosed typical illustrative embodiments of the invention and, although specific terms are employed, they are used in a generic and descriptive sense only and not for purposes of limitation, the scope of the invention being set forth in the following claims.

1. A method of estimating a cost savings attributable to use of a backup power system, the method comprising the following steps implemented in a data processing system:
obtaining historical power status information relating to operation of the backup power system; and
computing an estimate of cost savings from the obtained historical power status information.

2. The method of claim 1 wherein the obtained historical power status information comprises at least one of a number of power failures and a duration of the power failures.

3. The method of claim 2 further comprising:
obtaining a one-time cost factor for a single power failure; and
obtaining a cost per hour without power factor.

4. The method of claim 3 wherein computing an estimate of cost savings comprises:
calculating a per incident savings estimate based on the number of power failures and the one-time cost factor;
calculating an hourly savings estimate based on the duration of the power failures and the cost per hour without power factor; and
calculating the estimate of cost savings associated with the backup power system based on the calculated per incident savings estimate and the calculated hourly savings estimate.

5. The method of claim 4 further comprising exporting the per incident savings estimate, the hourly savings estimate and/or the estimate of cost savings to a computer application.

6. The method of claim 4 further comprising displaying the one-time cost factor, the cost per hour factor, the number of power failures, the duration of the power failures, the per incident savings estimate, the hourly savings estimate and the estimate of cost savings on a graphical user interface (GUI).

7. A method of estimating cost savings attributable to use of a backup power system, the method comprising the following steps implemented on a data processing system:
receiving historical power status information from a UPS over a communications link;
accepting a power outage cost factor from a user interface;
computing an estimate of cost savings based on the historical power status information and the power outage cost factor; and
displaying the estimate of cost savings on the user interface.

8. The method of claim 7 wherein the received historical power status information comprises at least one of a number of power failures and a duration of the power failures, wherein the power outage cost factor comprises a one-time cost factor for a single power failure and/or a cost per hour without power factor and wherein the user interface comprises a graphical user interface (GUI).

9. The method of claim 8 wherein computing an estimate of cost savings comprises:
calculating a per incident savings estimate based on the number of power failures and the one-time cost factor;
calculating an hourly savings estimate based on the duration of the power failures and the cost per hour without power factor; and
calculating an estimate of cost savings attributable to use of a backup power system based on the calculated per incident savings estimate and the calculated hourly savings estimate.

10. A calculator for estimating a cost savings attributable to use of a backup power system, comprising a data processor configured obtain historical power status information relating to operation of the backup power system and compute an estimate of cost savings from the obtained historical power status information.

11. The calculator of claim 10 wherein the data processor is operatively associated with a graphical user interface (GUI) and wherein the GUI is configured to receive the historical power status information and transmit the historical power status information to the data processor.

12. The calculator of claim 10 wherein the historical power status information comprises at least one of a number of power failures and a duration of the power failures.

13. The calculator of claim 12 wherein the data processor is further configured to:
receive a one-time cost factor for a single power failure and a cost per hour without power factor;
calculate a per incident savings estimate based on the number of power failures and the one-time cost factor;
calculate an hourly savings estimate based on the duration of the power failures and the cost per hour without power factor; and
calculate the estimate of cost savings attributable to use of a backup power system based on the calculated per incident savings estimate and calculated hourly savings estimate.

14. A computer program product for estimating a cost savings attributable to use of a backup power system, the computer program product comprising:
a computer readable medium having computer readable program code embodied therein, the computer readable program product comprising:
computer readable program code configured to obtain historical power status information relating to operation of the backup power system; and
computer readable program code configured to compute an estimate of cost savings from the obtained historical power status information.

15. The computer program product of claim 14 wherein the obtained historical power status information comprises at least one of a number of power failures and a duration of the power failures.

16. The computer program product of claim 14 further comprising:
computer readable program code configured to obtain a one-time cost factor for a single power failure; and
computer readable program code configured to obtain a cost per hour without power factor.

17. The computer program product of claim 16 wherein the computer readable program code configured to compute an estimate of cost savings comprises:
computer readable program code configured to calculate a per incident savings estimate based on the number of power failures and the one-time cost factor;
computer readable program code configured to calculate an hourly savings estimate based on the duration of the power failures and the cost per hour without power factor; and
computer readable program code configured to calculate the estimate of cost savings attributable to use of a backup power system based on the calculated per incident savings estimate and the calculated hourly savings estimate.

18. The computer program product of claim 17 further comprising computer readable program code configured to export the per incident savings estimate, the hourly savings estimate and/or the estimate of cost savings to a computer application.

19. The computer program product of claim 17 further comprising computer readable program code configured to display the one-time cost factor, the cost per hour factor, the number of power failures, the duration of the power failures, the per incident savings estimate, the hourly savings estimate and the estimate of cost savings on a graphical user interface (GUI).

20. A computer program product for estimating a cost savings attributable to use of a backup power system, the computer program product comprising:
a computer readable medium having computer readable program code embodied therein, the computer readable program product comprising:
computer readable program code configured to receive historical power status information from a uninterruptible power supply (UPS) over a communications link;
computer readable program code configured to accept a power outage cost factor from a user interface;
computer readable program code configured to compute an estimate of cost savings based on the historical power status information and the power outage cost factor; and
computer readable program code configured to display the estimate of cost savings on the user interface.

21. The computer program product of claim 20 wherein the received historical power status information comprises at least one of a number of power failures and a duration of the power failures, wherein the power outage cost factor comprises a one-time cost factor for a single power failure and/or a cost per hour without power factor and wherein the user interface comprises a graphical user interface (GUI)

22. The computer program product of claim 21 wherein the computer readable program code configured to compute an estimate of cost savings comprises:
computer readable program code configured to calculate a per incident savings estimate based on the number of power failures and the one-time cost factor;
computer readable program code configured to calculate an hourly savings estimate based on the duration of the power failures and the cost per hour without power factor; and
computer readable program code configured to calculate the estimate cost savings estimate attributable to use of a backup power system based on the calculated per incident savings and the calculated hourly savings.
